(19) United States
(12) Patent Application Publication
(10) Pub. No.: US 2008/0262944 A1
(43) Pub. Date: Oct. 23, 2008

(54) Online clothing display system and method therefor

(76) Inventor: Chih-Chen Wu, Pingtung City (TW)

Correspondence Address: REED SMITH LLP, Suite 1400, 3110 Fairview Park Drive, Falls Church, VA, 22042, US

(21) Appl. No.: 11/882,819

(22) Filed: Aug. 6, 2007

(30) Foreign Application Priority Data
Apr. 18, 2007 (TW) 096113711

(51) Int. Cl. G06F 17/30; G06Q 30/00; G06Q 90/00

(52) U.S. Cl. 705/27; 705/26

(57) ABSTRACT

An online clothing display system and method therefore are provided. The system includes a dressed mannequin, a rotating platform, an image recorder, and a mainframe. The mannequin stands on the rotating platform and is driven for rotating. In addition, the image recorder is utilized to capture the clothing images of the mannequin to obtain image files, which are transmitted to the mainframe. The mainframe further includes a web page for display the clothing images so that customers can view the clothing images from the web page through an internet and the customers can also match clothes and accessories from different online clothing and accessories stores. Besides, in the system, customers can input their body size data and obtain the information and suggestions about clothing sizes and matched accessories. Therefore, customers will less likely be bothered because of ordering the wrong clothes and not easy to change or refund.

This application claims the benefit of Taiwan Patent Application No. 096113711, filed on Apr. 18, 2007, which is hereby incorporated by reference for all purposes as if fully set forth herein.

### BACKGROUND OF THE INVENTION

1. Field of Invention

The present invention relates to a system and method for displaying the images of a dressed mannequin online to customers through a web page.

2. Related Art

Conventionally, online clothing and accessories stores usually display clothes and accessories on web pages by taken photos or draw pictures of the clothes and accessories into a plurality of image files. The image files are stored in a mainframe which is connected to internet; therefore, customers may view the images of the clothes and accessories through a browser.

However, there are some drawbacks in the prior art method. That is, the digital images of the clothes and accessories are mostly unable to be made by the store personnel, and they must be made by the professional. But, because different professionals take the images with different formats, the images of the clothes and accessories are unable to be matched with each other. In addition, most of online stores show their clothes or accessories with a single-plane view, so that the customers are unable to pair with different clothes and accessories by their need or favor. Although the technology of online fitting room is appeared to show the clothing after being dressed, the online fitting room only can currently be used to pair the clothes and accessories within a same online store because the image patterns and image formats of clothing and accessories may different in different online clothing and accessories stores. Therefore, if customers would like to pair different clothes purchased from different online stores, the customers have to use their imagination to think about the clothes after being paired. Moreover, usually online clothing and accessories stores only provide a mannequin with fixed size. In other words, the size of mannequin is unable to be changed or adjusted by inputting data in order to fit the size of a customer, so the paired clothes shown on online fitting room may not fit the customer in reality and also no suggestion is provided for the customer.

### SUMMARY OF THE INVENTION

In view of the above problems, an object of the present invention is to provide an online clothing display system and method for customers. The customers can use the system and method to look an article of clothing in different view angles and obtain a visual impression if the article of clothing is worn in a mannequin which has the same body size with the customer, so that the customer can use the system to find fitting clothing.

According to one embodiment of the present invention, the system includes a dressed mannequin, a rotating platform, an image recorder, and a mainframe connected to the image recorder. The dressed mannequin stands in the rotating platform, and the rotating platform is rotated with its axle center to drive the mannequin rotating. The image recorder captures images of the dressed mannequin to obtain at least one image file while the mannequin is rotated on the rotating platform, then the image files are transmitted and recorded on the mainframe. The contents of the image files show the dressed mannequin in different angles. In addition, those image files can be viewed directly from the mainframe or through a web page, so that customers can see the images of clothing on the web page through internet.

Moreover, any customer may input her/his body size data through the web page to build a mannequin which has completely the same body size with the customer; therefore, the mannequin can dress the clothes or accessories picked by the customer, and the mainframe can also provide the information and suggestions about clothing sizes and matched accessories for the customer by showing texts or voice message through the web page. Therefore, customers will less likely be bothered because of ordering the wrong clothes and not easy to change or refund from online clothing and accessories stores.

In addition, online clothing and accessories stores may provide the online fitting room procedure for customers to download from their web pages, so that the customers may use the online fitting room procedure to download the image files of clothes or accessories they bought and other clothes or accessories for sale from online clothing and accessories stores to try to mix and match clothes by their own favor, and the customer may also obtain the information and suggestions about clothing sizes and matched accessories from the online fitting room procedure as well.

The present invention can achieve the following effects: (1). The store personnel can finish making the image files of clothes and accessories by themselves. (2). The image files shot by the image recorder of the system are the same format; therefore, any customer can try to match clothes and accessories from different online clothing and accessories stores by her/her favor. (3). Any customer can input her/his body size data through the web page of a mainframe of the system to build a mannequin having completely the same body size with the customer, and then she/he can try to dress the clothes or accessories she/he picked in virtual reality. By using the system, the gap of visual impression she/he dressing the clothes or accessories between in a virtual reality and in a reality is very small, so that the customers can really find out whether the clothes or accessories they choose are really fitted. In addition, coordinate with the information and suggestions provided by the mainframe through the web page by texts or voice message, the customer can easy to choose the fittest clothing and accessories. (4). It is very convenience for any customers through their own computer connecting to internet to access the web page of the mainframe of the system, so that they can try to mix and match clothes or accessories they like in their computer without wasting time to go out.

The features and practice of the present invention will be illustrated below in detail through preferred embodiments with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 and FIG. 2 are schematic diagrams of the online clothing display system of the present invention;

FIG. 3 is a flow chart showing the online clothing display service of the present invention;

FIG. 3a is flow chart showing a first executing method of step s320 of the present invention;

FIG. 3b is flow chart showing a second executing method of step s320 of the present invention;

FIG. 4a is a schematic diagram showing a comparison area of the present invention; and

FIG. 4b is a system diagram after the system adding a sensing device.

### DETAILED DESCRIPTION OF THE INVENTION

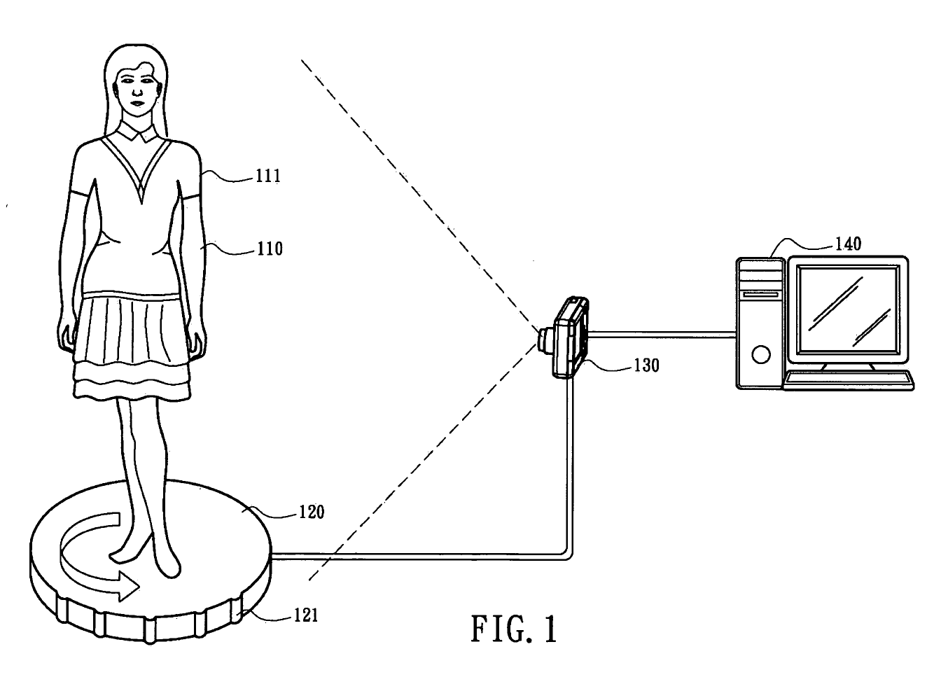

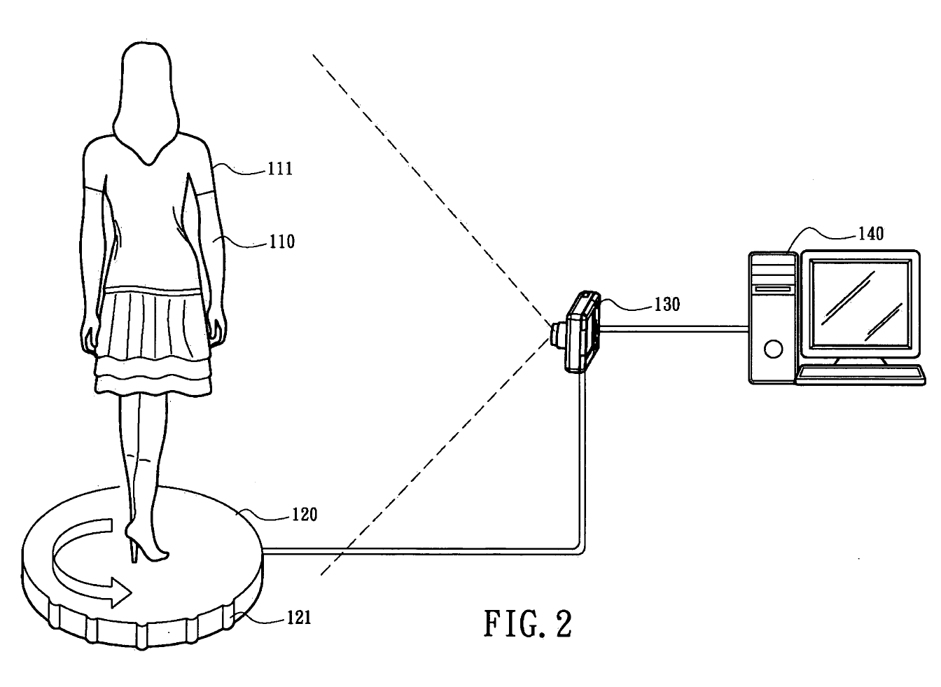

As shown in FIG. 1 and FIG. 2, they are schematic diagrams of the online clothing display system of the present invention. The online clothing display system includes a mannequin 1 10, a rotating platform 120, an image recorder 130, and a mainframe 140. The mannequin 110 dresses at least one article of clothing 111 and stands in the rotating platform 120. And the image recorder 130 focuses its lens to the dressed mannequin 110 and also connects to the mainframe 140. The mainframe 140 includes a database and a web page and connects to an internet.

The rotating platform 120 is rotated with its axle center, so as to drive the mannequin 110 rotating. The image recorder 130 captures images of the dressed mannequin 110 to obtain at least one image file while the mannequin 110 is rotated on the rotating platform 120. The image files may be continuous images or images in different view angles. Then the image files are transmitted and recorded on the database of the mainframe 140 by the image recorder 130. If the image files are continuous images, these images may be made as an animation film by the graphic process of the mainframe 140 and then the animation film is saved in the database of the mainframe 140. In addition, the animation film can be play in a web page to show the clothing dressed in the mannequin 110, and any customers may use an internet to access the web page to see the clothing images. No mater the image files of clothing are displayed by animation films or continuous images, customers can view the clothes in different view angles to see the visual effects of the clothing. Besides, a plurality of buttons may be disposed on the web page, and each button may correspond to a clothing image file saved on the database of the mainframe. Therefore, when a customer clicks a button, a corresponding image file will be opened from the database of the mainframe 140 and the clothing image of the image file will be shown on the web page. The customer may click several buttons to pair clothes or accessories she/he like.

In order to highlight the visual experience and feature of the clothing and accessory presentations, a background screen may be added behind the rotating platform when the image recorder captures the images of the dressed mannequin. The background screen is used as a background for the dressed mannequin. The color of background screen is different from the color of clothing. For example, if the clothing is white color, the background screen is better to use black color, deep blue color, or any dark colors. The purpose of using a background screen is to avoid that when the color of clothing is too similar with the color of background screen, the graphic process may be unable to identify the real style and features of the clothing so as to fail the image processing.

In addition, before the clothing image files are saved by the mainframe, the image portion of the mannequin can be erased by the graphic process and only the image portion of clothing is kept, so as to reduce data sizes to save space in the database of the mainframe and make easier for other purposes, such as creating advertising paper, image merge, or modifying features of the clothing.

Besides, any customers can input her/his body size data through the web page to build a mannequin which has completely the same body size with the customer; therefore, the mannequin can dress the clothes or accessories picked by the customer. After that, the customer can view the animation film or continuous images showing the dressed mannequin having the same body size with her/him what is look-alike in different view angles.

The online clothing and accessories stores may also provide the online fitting room procedure for customers to download from their web pages, so that the customers may use the online fitting room procedure to download the image files of clothes or accessories they bought and other clothes or accessories for sale from online clothing and accessories stores to try to mix and match clothes by their own favor, and the customer may also obtain the information and suggestions about clothing sizes and matched accessories from the online fitting room procedure as well. Therefore, customers may use an internet to enter the web page of the mainframe or use the online fitting room procedure downloaded in their computer to try to match clothes and accessories so as to increase convenience for the customers.

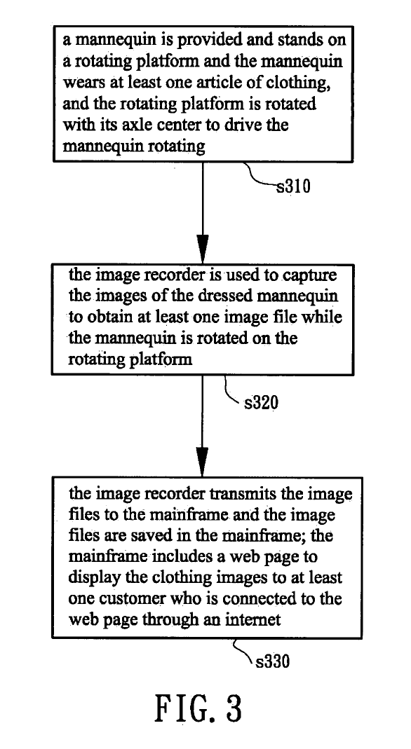

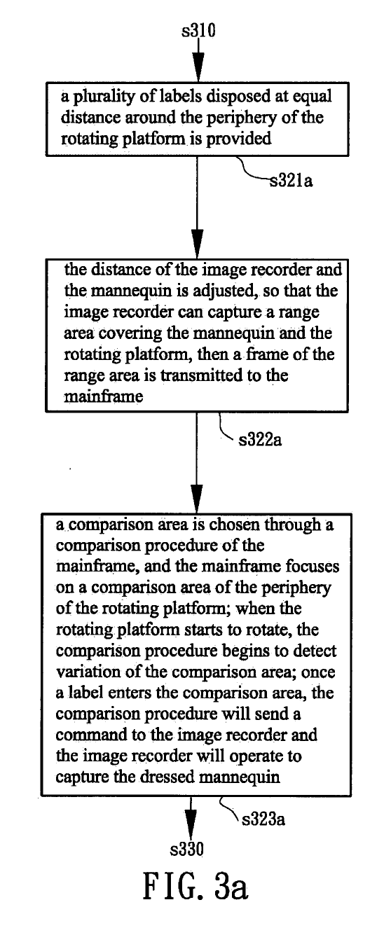

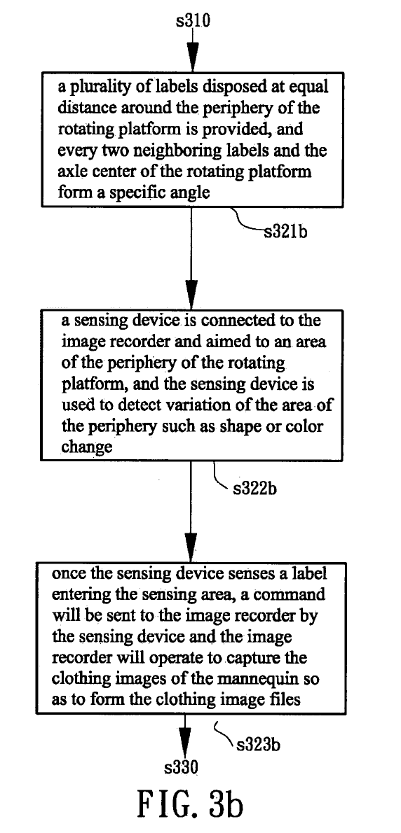

Please refer to FIG. 1, FIG. 2, and FIG. 3 together. FIG. 3 is a flow chart showing the online clothing display service of the present invention. A dressed mannequin is used, and the images of the dressed mannequin are taken by an image recorder from different view angles. And the images are shown on a web page by a mainframe, so that at least one customer can view the images. The method includes the steps of following:

A mannequin 110 is provided and stands on a rotating platform 120. The mannequin 110 wears at least one article of clothing, and the rotating platform 120 is rotated with its axle center to drive the mannequin 110 rotating (Step s310). The mannequin 110 can be a half body mannequin or a whole body mannequin and made by plastic, rubber or iron. Besides, the mannequin 110 wears at least one article of clothing or an accessory. One embodiment of the present invention takes the whole body mannequin as example. The rotating platform 120 is rotated with its axle center. Because the mannequin 110 stands on the rotating platform 120, the mannequin 110 is driven by the rotating platform 120 to rotate.

Then the image recorder 130 is used to capture the images of the dressed mannequin 110 to obtain at least one image file while the mannequin 110 is rotated on the rotating platform 120 (Step s320). When the dressed mannequin 110 is rotated, the images of the dressed mannequin 110 in different view angles are captured by the image recorder 130.

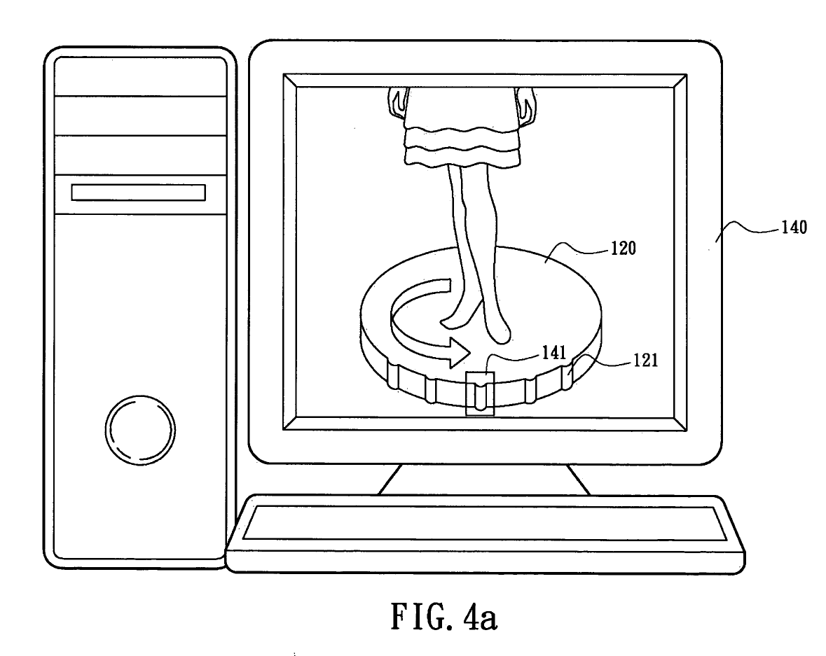

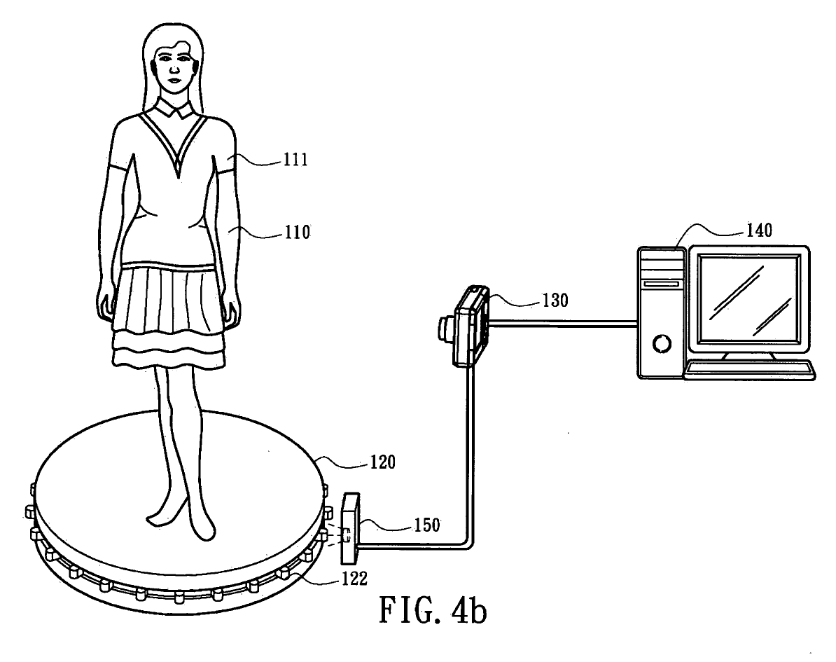

In addition, there are two ways to execute the step s320. The first way for execution please refers to FIG. 3a and FIG. 4a. The method at least includes the step of following:

A plurality of labels disposed at equal distance around the periphery of the rotating platform 120 is provided (Step s321a). Every two neighboring labels 121 and the axle center of the rotating platform 120 form a specific angle. In other words, for example, if the periphery of the rotating platform 120 is disposed with twelve labels 121 and every two neighboring labels 121 have equal distance, so that every two neighboring labels 121 and the axle center of the rotating platform 120 form an angle of 30°. Or if the periphery of the rotating platform 120 is disposed with sixty labels 121 and every two neighboring labels 121 have equal distance, so that every two neighboring labels 121 and the axle center of the rotating platform 120 form an angle of 6°.

Next, the image recorder 130 is adjusted to aim the mannequin 110 and the rotating platform 120. Then the distance of the image recorder 130 and the mannequin 110 is adjusted, and the focal length of the image recorder 130 is also adjusted, so that the image recorder 130 can capture a range area covering the mannequin 110 and the rotating platform 120. Then a frame of the range area is transmitted to the mainframe (Step s322a).

A comparison area 141 is chosen through a comparison procedure of the mainframe 140. In one embodiment, the mainframe 140 first chooses and focuses on a comparison area of the periphery of the rotating platform 120. When the rotating platform 120 starts to rotate, the comparison procedure begins to detect variation of the comparison area 141. Then once a label 121 enters the comparison area 141, the comparison procedure will send a command to the image recorder 130 and the image recorder 130 will operate to capture the dressed mannequin 110 (Step s323a).

And the second way for execution please refers to FIG. 3b and FIG. 4b. The method at least includes the step of following:

A plurality of labels 122 disposed at equal distance around the periphery of the rotating platform 120 is provided. Every two neighboring labels 121 and the axle center of the rotating platform 120 form a specific angle (Step s321b).

Then, a sensing device 150 is connected to the image recorder 130 and aimed to an area of the periphery of the rotating platform 120. The sensing device is used to detect variation of the area of the periphery such as shape or color change (Step s322b).

As mentioned above that the sensing device is connected to the image recorder 130 and aimed to an area of the periphery of the rotating platform 120, when the rotating platform 120 starts to rotate, the labels 122 will continuously enter the sensing area. Once the sensing device 150 senses a label 122 entering the sensing area, a command will be sent to the image recorder 130 by the sensing device 150 and the image recorder 130 will operate to capture the clothing images of the mannequin 110 so as to form the clothing image files (Step s323b).

No matter which way, the number of captured clothing image files will be the same as that of the labels.

After finishing image capture, the image recorder will transmit the image files to the mainframe, and the image files are saved in the mainframe. The mainframe includes a web page to display the clothing images to at least one customer who is connected to the web page through an internet (Step s330). If the image files of the dressed mannequin 110 are continuous images, these images can be made as an animation film by the graphic process of the mainframe 140 and then the animation film is saved in the database of the mainframe 140. Besides, a plurality of buttons can be disposed on the web page, and each button corresponds to a clothing image file saved on the database of the mainframe. Therefore, when a customer clicks a button, a corresponding image file will be opened from the database of the mainframe 140 and the clothing image of the image file will be shown on the web page.

The mainframe 140 further includes a calculation procedure. The calculation procedure can adjust the size and scale of the image files, so that the same style but different size's clothes do not need to capture their images repeatedly. Moreover, an input table is included in the web page, so that any customer can input her/his body size data such as shoulder width, chest perimeter, waist perimeter, hip perimeter, waist height, body height, and so on. Or face features and hair styles can be also selected, the calculation procedure calculates the related data to obtain and appear a mannequin having the same body size similar to that of the customer. Then, the customer can click the buttons on the web page to pick clothes or accessories to put on the mannequin, so that the customer can easy to find the fittest clothes or accessories for her/him to reduce the chances of buying wrong clothes or accessories. In addition, the size data inputted by the customer can be saved as a file in the database of the mainframe so as to be available for the customer to open the size data file through the web page; therefore, the mainframe can adjust the size of the mannequin according to the size data and show the image of the size-adjusted mannequin to the customer by the calculation procedure.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An online clothing display system, comprising:
a mannequin dressed at least one article of clothing;
a rotating platform for the mannequin to stand thereon and the rotating platform being rotated with its axle center to drive the mannequin rotating;
an image recorder for capturing clothing images of the mannequin to obtain at least one image file while the mannequin is rotated on the rotating platform; and
a mainframe connected to the image recorder to obtain the image file, and the mainframe further including a web page for display the clothing image of the image file so that customers can view the clothing image from the web page through an internet.

2. The online clothing display system as claimed in claim 1, wherein the rotating platform further includes a plurality of labels disposed at equal distance around periphery of the rotating platform and the mainframe further includes a comparison procedure, a range area of the image recorder covering the mannequin and the rotating platform and a frame of the range area being transmitted to the mainframe, then a comparison area being chosen by the comparison procedure and the comparison area corresponding to the periphery of the rotating platform, when the comparison procedure detecting the label entering the comparison area, the comparison procedure sending a command to the image recorder to capture the clothing image.

3. The online clothing display system as claimed in claim 1, further including a sensing device and the rotating platform further including a plurality of labels disposed at equal distance around periphery of the rotating platform, the sensing device being connected to the image recorder and aimed to an area of the periphery of the rotating platform, when the sensing device detecting the label entering a sensing range of the sensing device, the sensing device sending a command to the image recorder to capture the clothing image and obtain the image file of the clothing image.

4. The online clothing display system as claimed in claim 1, wherein the mainframe includes a database for saving the image file.

5. The online clothing display system as claimed in claim 4, wherein the web page comprises a plurality of buttons, each button being corresponding to one image file saved in the database, when any button being clicked, the web page displaying image of the corresponding image file.

6. The online clothing display system as claimed in claim 1, further including a background screen, the background screen being disposed behind the mannequin and the rotating platform so as to cover the range area of the image recorder.

7. An online clothing display method in which clothing images of a mannequin dressed at least one article of clothing are captured in different view angles and the clothing images are displayed in a web page through a mainframe so that at least one customer can view the clothing images, the online clothing display method includes steps of:
providing a mannequin standing on a rotating platform, the mannequin wearing at least one article of clothing and the rotating platform being rotated with its axle center to drive the mannequin rotating;
using an image recorder to capture clothing images of the mannequin to obtain at least one image file while the mannequin being rotated on the rotating platform; and
transmitting the image files to the mainframe, the mainframe including a web page to display the clothing images of the image files to at least one customer connected to the web page through an internet for viewing.

8. The online clothing display method as claimed in claim 7, wherein the step of using an image recorder to capture clothing images of the mannequin to obtain at least one image file while the mannequin being rotated on the rotating platform includes steps of:
disposing a plurality of labels at equal distance around periphery of the rotating platform;
adjusting a distance of the image recorder and the mannequin, so that the image recorder can capture a range area covering the mannequin and the rotating platform, then a frame of the range area is transmitted to the mainframe; and
utilizing a comparison procedure of the mainframe to choose a comparison area, the comparison area corresponding to the periphery of the rotating platform, when the label entering the comparison area, the comparison procedure sending a command to the image recorder and the image recorder operating to capture the clothing images of the mannequin.

9. The online clothing display method as claimed in claim 7, wherein the step of using an image recorder to capture clothing images of the mannequin to obtain at least one image file while the mannequin being rotated on the rotating platform includes steps of:
disposing a plurality of labels at equal distance around periphery of the rotating platform;
connecting a sensing device to the image recorder and the image recorder being aimed to an area of the periphery of the rotating platform; and
sensing the label entering the sensing area by the sensing device, then a command being sent to the image recorder by the sensing device and the image recorder operating to capture the clothing images of the mannequin so as to form the clothing image files.
